(19) United States
(12) Patent Application Publication
(10) Pub. No.: US 2022/0176887 A1
(43) Pub. Date: Jun. 9, 2022

(54) INTERIOR STRUCTURE OF VEHICLE DOOR

(71) Applicant: Honda Motor Co., Ltd., Tokyo (JP)

(72) Inventors: Takashi KUMAMOTO, Saitama (JP); Keita ISHIZAKA, Tokyo (JP); Takuya Okano, Tochigi (JP)

(73) Assignee: Honda Motor Co., Ltd., Tokyo (JP)

(21) Appl. No.: 17/536,081

(22) Filed: Nov. 28, 2021

(30) Foreign Application Priority Data
Dec. 3, 2020 (JP) 2020-200959

(51) Int. Cl. B60R 11/02; H04R 5/02

(52) U.S. Cl. CPC B60R 11/0217; B60R 2011/0021; H04R 5/02

(57) ABSTRACT

An interior structure of a vehicle door includes a door interior panel 11 and a bezel garnish 16. The door interior panel 11 is attached to a compartment inner side of a door inner panel. The bezel garnish 16 is attached to a periphery of an opening formed in the door interior panel 11. In the bezel garnish 16, a locking part to which a speaker grill 17 of a door speaker and a cover-shaped auxiliary interior panel are selectively attachable is provided.

### CROSS-REFERENCE TO RELATED APPLICATION

This application claims the priority benefit of Japan application serial no. 2020-200959, filed on Dec. 3, 2020. The entirety of the above-mentioned patent application is hereby incorporated by reference herein and made a part of this specification.

### BACKGROUND

### Technical Field

The disclosure relates to an interior structure of a vehicle door.

### Description of Related Art

Regarding the side door of a vehicle, a door interior panel made of resin is attached to the compartment inner side of a door inner panel. In the door interior panel, a switch operation part or an arm rest and a door pocket are formed integrally, and a speaker grill of a door speaker, etc., is also provided (see Patent Documents 1 and 2, etc., for example).

### PRIOR ART DOCUMENT

### Patent Document(s)

[Patent Document 1] Japanese Laid-open No. S61-132443
[Patent Document 2] International Publication No. 2005/115050

Regarding the interior structure of the vehicle door including the door interior panel, the specification of the door interior panel needs to change in a vehicle in which a specific door speaker is mounted to the side door and a vehicle in which such door speaker is not mounted. That is, it is necessary to form a speaker grill located opposite to the sound emitting part of the speaker for the vehicle in which the specific door speaker is mounted to the side door, whereas the speaker grill is not needed for the vehicle in which the specific speaker is not mounted to the side door.

Therefore, in the manufacturing site of the interior structure, in order to separately manufacture multiple door interior panels, many manufacturing apparatuses are required. Since these apparatuses are operated individually, the production efficiency drops.

### SUMMARY

An aspect of the disclosure provides an interior structure of a vehicle door. The interior structure includes: a door interior panel attached to a compartment inner side of a door inner panel; and a bezel garnish, attached to a periphery of an opening formed in the door interior panel. In the bezel garnish, a locking part to which a speaker grill of a door speaker and a cover-shaped auxiliary interior panel are selectively attachable is provided.

According to an embodiment of the disclosure, in the interior structure of the vehicle door, the bezel garnish and the auxiliary interior panel are formed in a same color with a periphery part of the opening of the door interior panel.

According to an embodiment of the disclosure, in the interior structure of the vehicle door, a woofer is provided at a lower part on a vehicle front side in the door interior panel, the opening is provided above the woofer and at a location on a vehicle front side of a switch operation part formed to bulge on the door interior panel, and a squawker, which is the door speaker, is provided in the opening.

According to an embodiment of the disclosure, in the interior structure of the vehicle door, the bezel garnish includes: an annular part, provided around the opening; and a rear extension part, extending from an upper side of the annular part to a vehicle rear side to pass above the switch operation part.

### BRIEF DESCRIPTION OF THE DRAWINGS

FIG. 1 is a plan view of a vehicle according to an embodiment.

FIG. 2 is a perspective view in a compartment of a vehicle according to an embodiment.

FIG. 3 is a perspective view illustrating a state in which a front door of a vehicle is open according to an embodiment.

FIG. 4 is a cross-sectional view of a front door according to an embodiment taken along a line IV-IV of FIG. 3.

FIG. 5 is an exploded perspective view of an assembly of interior components according to an embodiment.

FIG. 6 is a cross-sectional view, similar to FIG. 4, of a front door according to an embodiment in which other interior components are mounted.

FIG. 7 is an exploded perspective view of an assembly of other interior components according to an embodiment.

### DESCRIPTION OF THE EMBODIMENTS

The disclosure provides an interior structure of a vehicle door capable of increasing the production efficiency by making it possible for the vehicle in which the door speaker is mounted and the vehicle in which the door speaker is not mounted to share the same door inner panel.

An interior structure of a vehicle door according to the disclosure adopts a configuration as follows.

That is, an interior structure of a vehicle door according to the disclosure includes: a door interior panel (e.g., the door interior panel 11 of the embodiment) attached to a compartment inner side of a door inner panel (e.g., the door inner panel 10 of the embodiment); and a bezel garnish (e.g., the bezel garnish 16 of the embodiment), attached to a periphery of an opening (e.g., the opening 15 of the embodiment) formed in the door interior panel. In the bezel garnish, a locking part (e.g., the end surface 18a and the notch parts 20 of the embodiment) to which a speaker grill (e.g., the speaker grill 17 of the embodiment) of a door speaker (e.g., the squawker 2S of the embodiment) and a cover-shaped auxiliary interior panel (e.g., the auxiliary interior panel 30 of the embodiment) are selectively attachable is provided.

In the vehicle in which the door speaker is provided in the opening of the door interior panel, the speaker grill is attached to the locking part of the bezel garnish. Accordingly, the speaker grill is provided on the inner side of the bezel garnish. In the vehicle in which a speaker is not provided in the opening of the door interior panel, the auxiliary interior panel is attached to the locking part of the bezel garnish. Accordingly, the opening on the inner side of the bezel garnish is blocked by the auxiliary interior panel.

The bezel garnish and the auxiliary interior panel may be formed in a same color with a periphery part of the opening of the door interior panel.

In such case, the bezel garnish and the auxiliary interior panel have a continuous appearance with the periphery part of the opening of the door interior panel, and the look from the outside is favorable.

A woofer (e.g., the woofer 2U of the embodiment) may be provided at a lower part on a vehicle front side in the door interior panel. The opening may be provided above the woofer and at a location on a vehicle front side of a switch operation part (e.g., the switch operation part 13 of the embodiment) formed to bulge on the door interior panel. A squawker (e.g., the squawker 2S of the embodiment), which is the door speaker, may be provided in the opening.

In this case, in the limited space of the vehicle door, the woofer for deep bass output and the squawker 2S mid-range sound output can be efficiently provided. Thus, if a tweeter for high-pitched sound output is further provided in the front pillar or the upper part of the vehicle door, a three-way speaker system on the side part in the compartment is established, and a clear and smooth acoustic space can be realized.

The bezel garnish may have a structure including: an annular part (e.g., the annular part 16a of the embodiment), provided around the opening; and a rear extension part (e.g., the rear extension part 16b of the embodiment), extending from an upper side of the annular part to a vehicle rear side to pass above the switch operation part.

In this case, since the rear extension part of the bezel garnish extends to the vehicle rear side to pass above the switch operation part, the sense of integrity between the bezel garnish and the door interior panel can be enhanced by the rear extension part, and the rigidity of the attachment part on the upper side of the bezel garnish can be increased. Therefore, at the time when a great external force is exerted to the bezel garnish from the top, the bezel garnish can be prevented from slipping or falling off.

According to the disclosure, the bezel garnish is attached to the periphery of the opening formed in the door interior panel, and it is possible to selectively attach the speaker grill of the door speaker and the cover-shaped auxiliary interior panel to the locking part of the bezel garnish. Therefore, the same door interior panel can be shared by the vehicle in which the door speaker is mounted to the opening of the door interior panel and the vehicle in which the door speaker is not mounted. Thus, in the case where the disclosure is adopted, the productivity of the interior structure of the vehicle door can be increased, and the product cost can be reduced.

In the following, the embodiment of the disclosure will be described with reference to the drawings.

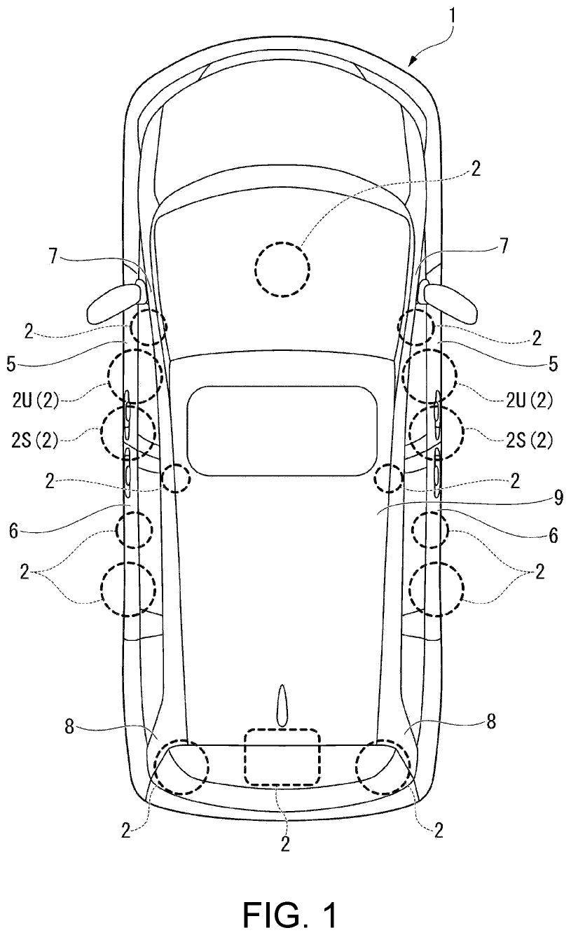

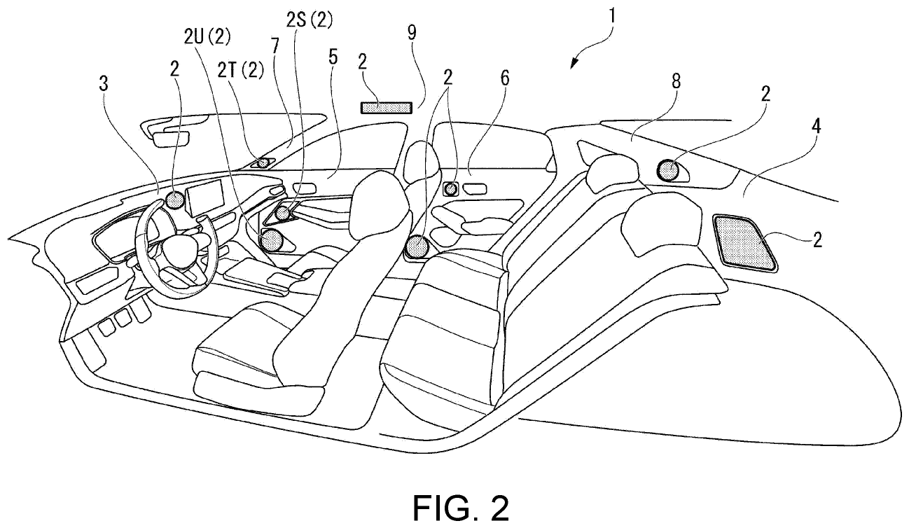

FIG. 1 is a plan view of a vehicle 1 according to an embodiment, and FIG. 2 is a perspective view in a compartment of the vehicle 1 according to an embodiment. 16 speakers 2 are mounted in the compartment of the vehicle 1. Specifically, one speaker 2 is mounted to each of the center of an instrument panel 3 at the front of the compartment and a rear parcel shelf 4 at the rear of the compartment, two speakers 2 are mounted to each of a front door 5 and a rear door 6 on each of the left and the right, and one speaker 2 is mounted to each of a front pillar 7, a rear pillar 8, and a roof side part 9 on each of the left and the right.

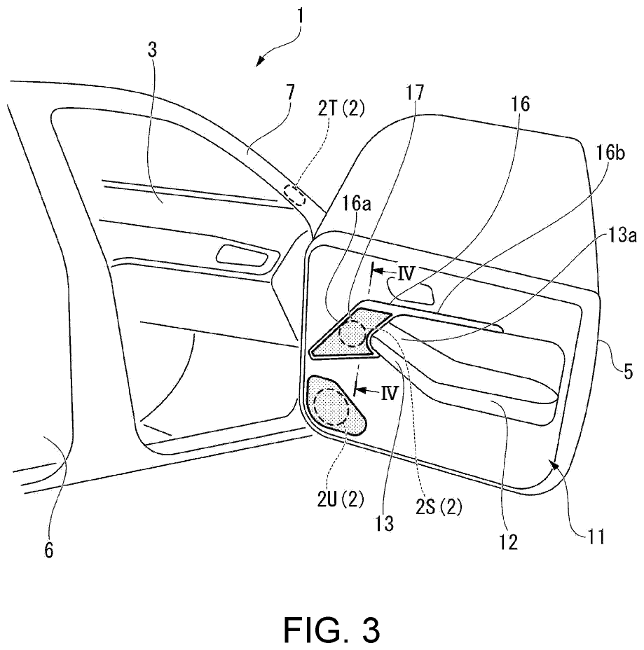

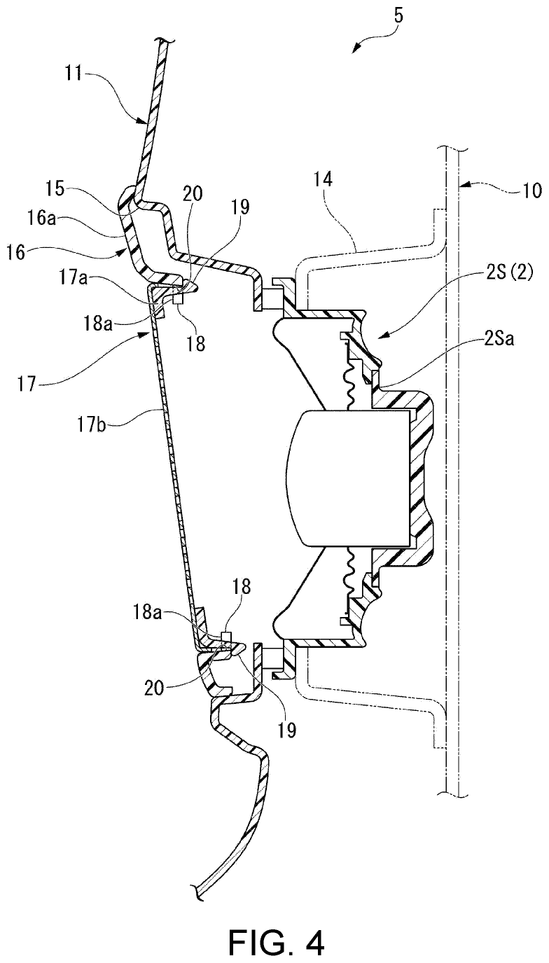

FIG. 3 is a perspective view illustrating the vehicle 1 in which the front door 5 is open. FIG. 4 is a cross-sectional view illustrating the front door 5 and taken along a line IV-IV of FIG. 3.

In the front door 5, a door interior panel 11 made of resin is attached to the vehicle inner side of a door inner panel 10. At the substantially central part of the door interior panel 11 in the height direction, an arm rest 12 and a switch operation part 13 are formed to bulge toward the vehicle inner side. The arm rest 12 extends from the vicinity of the rear end part of the door interior panel 11 to a substantially central position in the front-rear direction, and the switch operation part 13 is integrally formed with the front part of the arm rest 12. The switch operation part 13 has an inclined surface 13a inclined obliquely upward toward the front of the vehicle from the front end part of the arm rest 12 and provided with multiple switch types (not shown), such as a glass lifting switch, on the inclined surface 13a.

A woofer 2U (2), which is the speaker 2 for deep bass output, is provided at a lower part on the vehicle front side in the door interior panel 11. In addition, a squawker 2S (2), which is the speaker 2 for mid-range sound output, is provided above the woofer 2U (2) and at a location on the vehicle front side of the switch operation part 13 in the door interior panel 11. In the embodiment, the squawker 2S (2) forms a door speaker.

A body part 2Sa of the squawker 2S (2) is attached to the door inner panel 10 via a bracket 14, as shown in FIG. 4. It is noted that the body part 2Sa of the squawker 2S (2) may be attached to any of the door interior panel 11, a bezel garnish 16 to be described afterwards, and a grill bracket 17a to be described afterwards. An opening 15 in a predetermined shape is formed at a location opposite to the body part 2Sa of the squawker 2S (2) of the door interior panel 11. The opening 15 is formed in a distorted parallelogram shape in which the front side on the vehicle front side and the rear side on the vehicle rear side are inclined downward toward the front side.

The bezel garnish 16 is attached to the periphery of the opening 15 of the door interior panel 11 by an appropriate means such as screw fastening, adhesion, etc. The bezel garnish 16 is integrally formed by a resin in the same color with the periphery of the opening 15 of the door interior panel 11. The speaker grill 17 of the squawker 2S (door speaker) is detachably attached to the bezel garnish 16.

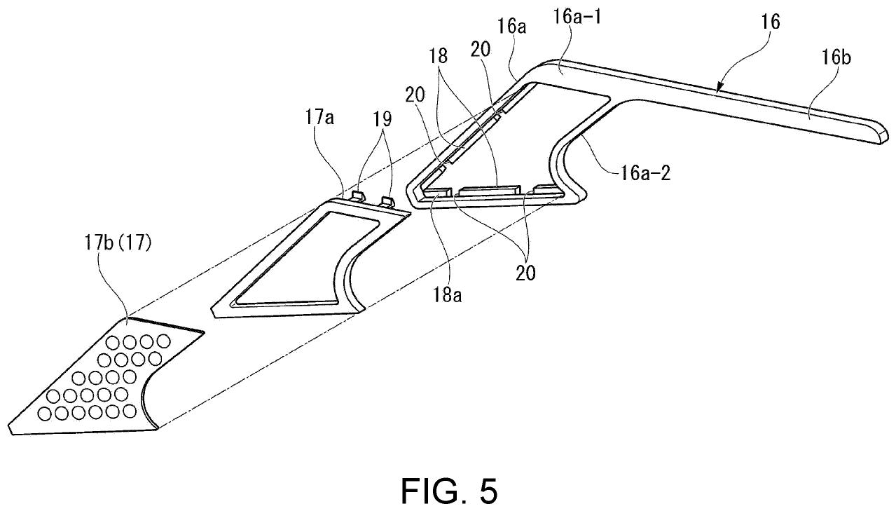

FIG. 5 is an exploded perspective view of an assembly of the bezel garnish 16 and the speaker grill 17.

As shown in FIG. 5, the bezel garnish 16 includes an annular part 16a formed in a distorted parallelogram shape along the periphery part of the opening 15 of the door interior panel 11 and a rear extension part 16b linearly extending from an upper side 16a-1 of the annular part 16a toward the vehicle rear side. A rear side 16a-2 of the annular part 16a is formed to be partially curved along the shape of the front end part of the switch operation part 13 shown in FIG. 3. In the state where the bezel garnish 16 is attached to the periphery of the opening 15 of the door interior panel 11, the rear extension part 16b substantially horizontally extends toward the vehicle rear side to pass above the switch operation part 13.

The annular part 16a of the bezel garnish 16 is provided with a locking flange 18 formed by bending the inner periphery part on the back side (vehicle outer side) in a stepped shape. The locking flange 18 is formed with multiple notch parts 20 into which locking claws 19 of an auxiliary interior panel 30 or the speaker grill 17 to be described afterwards is inserted. In the embodiment, an end surface 18a of the locking flange 18 on the vehicle inner side and the notch parts 20 form a locking part in the bezel garnish 16.

The speaker grill 17 includes a grill body 17b formed by a metal plate and having multiple sound emitting holes and a grill bracket 17a made of resin and supporting the periphery part of the grill body 17b. The grill bracket 17a is a frame-like member having an outer surface shape which may be fit into the inner circumferential surface of the bezel garnish 16. The outer periphery part of the grill body 17b is fixed to the vehicle outer side of the grill bracket 17a by screw fastening, recess/projection fitting, etc. In addition, at multiple locations of the grill bracket 17a, the locking claws 19 which may be inserted into the notch parts 20 formed in the locking flange 18 of the bezel garnish 16 are protrusively provided.

In the case where the speaker grill 17 is attached to the bezel garnish 16, the grill body 17b is attached to the grill bracket 17a in advance, and the grill bracket 17a is fit into the inner circumferential surface of the annular part 16a of the bezel garnish 16 in such state. At this time, the locking claws 19 of the grill bracket 17a are inserted into the corresponding notch parts 20 on the side of the bezel garnish 16, and the end surface of the grill bracket 17a on the vehicle outer side, excluding the locking claws 19, abuts against the locking flange 18 of the bezel garnish 16. At this time, the locking claws 19 on the side of the grill bracket 17a are elastically deformed while being inserted into the notch parts 20, and are elastically restored at the time of overcoming the notch parts 20 and locked and fixed to the edges of the notch parts 20. As a result, the speaker grill 17 is fixed to the inner circumferential side of the bezel garnish 16. It is noted that, the speaker grill 17 is formed by two components, i.e., the grill body 17b and the grill bracket 17a, in the embodiment, but the speaker grill 17 may also be formed as an integral component entirely made of resin.

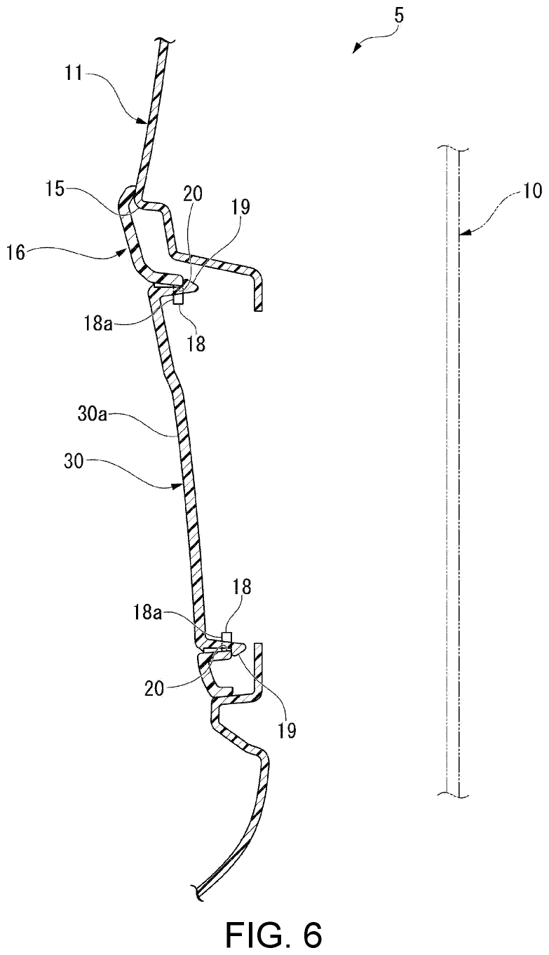

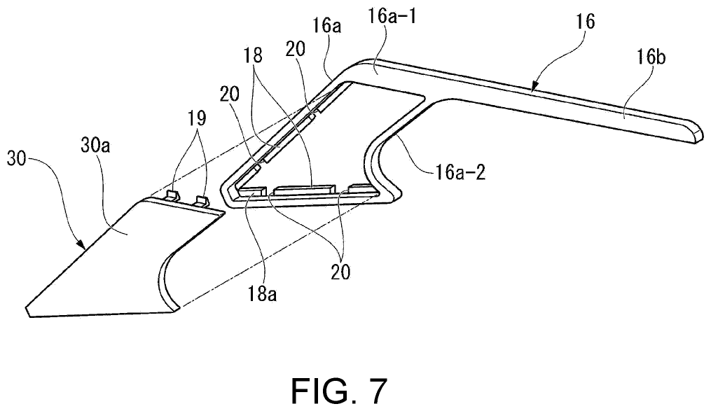

FIG. 6 is a cross-sectional view, similar to FIG. 4, of the front door 5 with the specification in which the squawker 2S is not mounted. FIG. 7 is an exploded oblique view of an assembly of interior components used in the front door 5 with the specification in which the squawker 2S is not mounted.

In the front door 5 with such specification, the door interior panel 11 and bezel garnish 16 same as those of the front door 5 with the specification in which the squawker 2S is mounted are used. However, in place of the speaker grill 17, the auxiliary interior panel 30, which is in a cover shape, is detachably attached to the inner periphery part of the bezel garnish 16.

The auxiliary interior panel 30 is integrally formed by resin in the same color with the bezel garnish 16 or the door interior panel 11. The auxiliary interior panel 30 includes a base part 30a in an outer surface shape which may be fit into the inner circumferential surface of the bezel garnish 16 and the locking claws 19 formed to protrude from the outer periphery part of the base part 30a toward the vehicle outer side.

In the case where the auxiliary interior panel 30 is attached to the bezel garnish 16, the auxiliary interior panel 30 is fit into the inner circumferential surface of the annular part 16a of the bezel garnish 16. At this time, the locking claws 19 of the auxiliary interior panel 30 are inserted into the corresponding notch parts 20 on the side of the bezel garnish 16, and the end surface of the outer periphery part of the auxiliary interior panel 30 on the vehicle outer side, excluding the locking claws 19, abuts against the locking flange 18 of the bezel garnish 16. At this time, the locking claws 19 on the side of the auxiliary interior panel 30 are elastically deformed while being inserted into the notch parts 20, and are elastically restored at the time of overcoming the notch parts 20 and locked and fixed to the edges of the notch parts 20. As a result, the auxiliary interior panel 30 is fixed to the inner circumference side of the bezel garnish 16.

According to the above, in the interior structure of the vehicle door according to the embodiment, the bezel garnish 16 is attached to the periphery of the opening 15 of the door interior panel 11, and it is possible to selectively attach the speaker grill 17 and the cover-shaped auxiliary interior panel 30 to the locking part (the end surface 18a of the locking flange 18 on the vehicle inner side and the notch parts 20) of the bezel garnish 16. Therefore, the vehicle in which the door speaker (squawker 2S) is mounted to the opening 15 of the door interior panel 11 and the vehicle in which the door speaker (squawker 2S) is not mounted can share the same door interior panel 11. Thus, in the case where the interior structure of the front door 5 of the embodiment is adopted, the productivity of the interior structure can be increased, and the product cost can be reduced.

Moreover, in the interior structure of the vehicle door according to the embodiment, the bezel garnish 16 and the auxiliary interior panel 30 are formed in the same color with the periphery part of the opening 15 of the door interior panel 11. Therefore, the bezel garnish 16 and the auxiliary interior panel 30 have a continuous appearance with the periphery part of the opening 15 of the door interior panel 11, and the look from the outside is favorable.

In addition, in the interior structure of the vehicle door according to the embodiment, the woofer 2U for deep bass output is provided at a lower part in the door interior panel 11 on the vehicle front side, the opening 15 is provided above the woofer 2U and at a location on the front side of the switch operation part 13, and the squawker 2S for mid-range sound output is provided in such opening. Therefore, in the limited space of the front door 5, the woofer 2U for deep bass output and the squawker 2S for mid-range sound output are efficiently provided. Therefore, the interior structure of the vehicle door according to the embodiment establishes a three-way speaker system on the side part in the compartment, together with a tweeter 2T for high-pitched sound output provided at the front pillar 7, and can provide a clear and smooth acoustic space.

Moreover, in the interior structure of the vehicle door according to the embodiment, the bezel garnish 16 includes the annular part 16a around the opening 15 and the rear extension part 16b extending from the upper side of the annular part 16a toward the vehicle rear side to pass above the switch operation part 13. Therefore, the sense of integrity between the bezel garnish 16 and the door interior panel 11 can be enhanced by the rear extension part 16b, and the rigidity of the attachment part of the bezel garnish 16 on the upper side can be increased. Therefore, in the case where the configuration is adopted, at the time when a great external force is exerted to the bezel garnish 16 from the top, the bezel garnish 16 can be prevented from slipping or falling off.

The disclosure is not limited to the above embodiment, and various design changes can be made without departing from the gist thereof.

What is claimed is:

1. An interior structure of a vehicle door, comprising:
a door interior panel attached to a compartment inner side of a door inner panel; and
a bezel garnish, attached to a periphery of an opening formed in the door interior panel,
wherein in the bezel garnish, a locking part to which a speaker grill of a door speaker and a cover-shaped auxiliary interior panel are selectively attachable is provided.

2. The interior structure of the vehicle door as claimed in claim 1, wherein the bezel garnish and the auxiliary interior panel are formed in a same color with a periphery part of the opening of the door interior panel.

3. The interior structure of the vehicle door as claimed in claim 1, wherein a woofer is provided at a lower part on a vehicle front side in the door interior panel,
the opening is provided above the woofer and at a location on a vehicle front side of a switch operation part formed to bulge on the door interior panel, and
a squawker, which is the door speaker, is provided in the opening.

4. The interior structure of the vehicle door as claimed in claim 3, wherein the bezel garnish comprises:
an annular part, provided around the opening; and
a rear extension part, extending from an upper side of the annular part to a vehicle rear side to pass above the switch operation part.

5. The interior structure of the vehicle door as claimed in claim 2, wherein a woofer is provided at a lower part on a vehicle front side in the door interior panel,
the opening is provided above the woofer and at a location on a vehicle front side of a switch operation part formed to bulge on the door interior panel, and
a squawker, which is the door speaker, is provided in the opening.
